(19) United States
(12) Patent Application Publication
(10) Pub. No.: US 2008/0199292 A1
(43) Pub. Date: Aug. 21, 2008

(54) Automated guided vehicle with an improved mutiple-pallet lifting group

(75) Inventor: Emanuele Gatteschi, Parma (IT)

Correspondence Address: HEDMAN & COSTIGAN P.C., 1185 AVENUE OF THE AMERICAS, NEW YORK, NY, 10036, US

(73) Assignee: OCME S.r.l., Parma (IT)

(21) Appl. No.: 12/069,655

(22) Filed: Feb. 12, 2008

(30) Foreign Application Priority Data
Feb. 20, 2007 (IT) MI2007A 000326

(51) Int. Cl. B66F 19/00

(52) U.S. Cl. 414/607

(57) ABSTRACT

An automatic guided vehicle (10) with an improved multiple-pallet lifting group comprising a machine body (11) provided with means for its movement (12) and a lifting group (13) constrained to the machine body (11), wherein the lifting group (13) comprises a multilevel post structure (14), a lift truck (15), a tilting plate (17) which constitutes the framework of a multiple-pallet clamp group (18) provided with three pairs (19′, 19″, 19′″) of forks (19) arranged in a specular manner with respect to a longitudinal centreline plane (22) of the machine body (11) and moveable along horizontal guides (20) constrained to the framework (17), the clamp group (18) comprising per each pair (19′, 19″, 19′″) of forks (19) two actuators (21) for the independent control of each fork (19), a pair (24′, 24″, 24′″) of two oppositely positioned racks (24) joined integrally to the respective forks (19) and at least one toothed wheel (23′, 23″, 23′″) which engages the pair of corresponding racks (24′, 24″, 24′″).

The present invention regards an automated guided vehicle with an improved multiple-pallet lifting group. Automatic guided vehicles for transport of loose, packaged or palletized products inside factories or warehouses are known. Such automatic guided vehicles are for example of the wire guided type or of the gyroscope type, adapted to follow preset guides, or else of the laser-guide type programmable to follow any kind of path.

Automatic guided vehicles can be provided with a lifting group for palletized products and thus serve as a lift truck or as a forklift.

Lift trucks meet the need to allow quick movement of a large amounts of products, which, alongside being generally heavy, they are stacked in special units called “pallets”. This movement of products usually occurs through methods quite common to all current lift trucks.

In particular, first and foremost, the vehicle is neared to the pallet intended to be moved. Once reached, the pallet is “seized” at the lower part by means of forks and eventually lifted and secured integrally to the lift truck due to particular movements of the forks themselves. Once reached such configuration the lift truck is free to move and shift until it reaches the position at which it is to proceed, through steps opposite to the ones that had characterised seizure and lifting of the pallet, to laying and positioning of the same pallets.

According to the above outlined description it is observed that the forks, which have the function of seizing, lifting, securing to the lift truck and, subsequently, laying the product, play a crucial role in such movement procedure of products stacked in pallets.

The forks, which may vary in terms of numbers and sizes, have an L-shaped profile whose vertical side extends parallel to the front section of the lift truck, and can serve as a support base for the products during transport, while the horizontal one, projecting longitudinally, allows to seize and support the pallet at the lower part in a firm manner.

Usually such forks are free to perform given movements, with respect to the lift truck, such as a vertical translation movement along some vertical guides fixed onto the lift truck, and in some cases also horizontally, along horizontal guides.

Furthermore, a rotation around a horizontal axis can be allowed, to incline the products towards the lift truck and, alongside enhancing the stability of the system, compensate for downward elastic deformation of the forks caused by the weight of the products themselves. The abovementioned movements allow to firmly seize and secure the pallet intended to be moved.

In order to obtain a good seizure and lifting, the forks are usually provided in even numbers and, in particular, two adjacent forks engage the same pallet. Currently, lift trucks with two or three pairs of forks are also used, in such a manner to allow movement of more products within a shorter period of time.

However, current automatic guided vehicles provided with a lifting group exclusively adopt fixed forks systems for the seizure of pallets of preset standard sizes and thus do not allow to move different types of one or more pallets.

As a matter of fact, only traditional lift trucks manoeuvred by an operator on board the same lift truck can be provided with multiple-pallet lifting groups with forks adjustable at various positions.

Even traditional lift trucks known today, with their relative lifting groups, have some drawbacks.

If the traditional lift truck is provided with a multiple-pallet clamp, these drawbacks for example may arise from poor accuracy when positioning the forks or from the failure to be provided with a variable distance between all the adjacent forks present.

As a matter of fact, in the common multiple-pallet clamps of traditional lift trucks in the market, two adjacent forks are part of two separate pairs wherein usually only one can be freely positioned at a variable centre distance within a determined range of movement.

In the presence of a single pump for all the systems, the operation of a single pair forks, using a flow separator to convey oil only to the two actuators present, can lead to non-simultaneity of the forks of the same pair and above all to repeatability errors in their positioning.

A second drawback regards a non-controllable centre distance between all the forks and this is due to the fact that in the multiple-pallet clamps of the traditional lift trucks, only the external forks are controlled hydraulically while the other forks connected thereto by means of a device, such as for example a gas spring, which determines its only two/three possible configurations.

These drawbacks are such that a traditional multiple-pallet clamp cannot be used for a lift truck without an operator on board, that is an automatic guided vehicle, for which accuracy and repeatability of movements of the forks are key factors.

Additionally, such traditional equipments, combined with an automatic guided vehicle, do not guarantee an adequate level of accident prevention.

As a matter of fact, falls or erroneous positioning of pallets can lead to economical losses, such as breakage of products, but they might also expose the personnel near the lift truck to danger, given that the material moved is generally very heavy.

The objective of the present invention is that of providing an automatic guided vehicle provided with an improved multiple-pallet lifting group serving as a lift truck provided with a multiple-pallet clamp capable of overcoming the abovementioned drawbacks.

Another objective is that of providing an automatic guided vehicle with an improved multi-pallet lifting group with an ideal synchronisation of the pairs of forks and with centre distances relatively variable between all the forks.

Still another objective is that of being in a position to provide an automatic guided vehicle with an improved multiple-pallet lifting group provided with a safety and accident prevention system.

These objectives according to the present invention are attained by manufacturing an automatic guided vehicle with an improved multiple-pallet lifting group as described in claim 1.

Further characteristics of the invention are described in the subsequent claims.

Characteristics and advantages of an automatic guided vehicle with an improved multiple-pallet lifting group according to the present invention shall be clearer from the following exemplifying and non-limiting description with reference to the schematic drawings attached wherein:

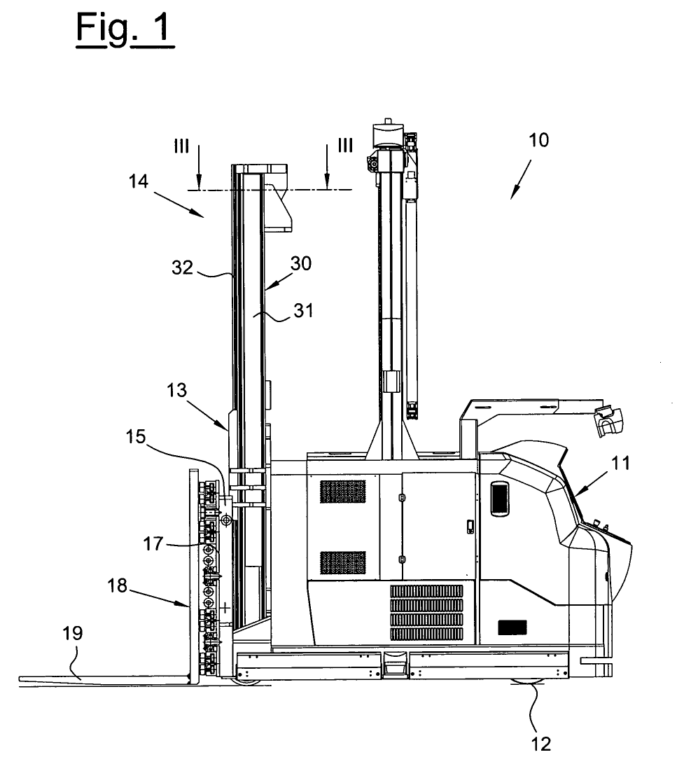

FIG. 1 is a partially sectioned side view of an automatic guided vehicle with an improved multiple-pallet lifting group according to the present invention;

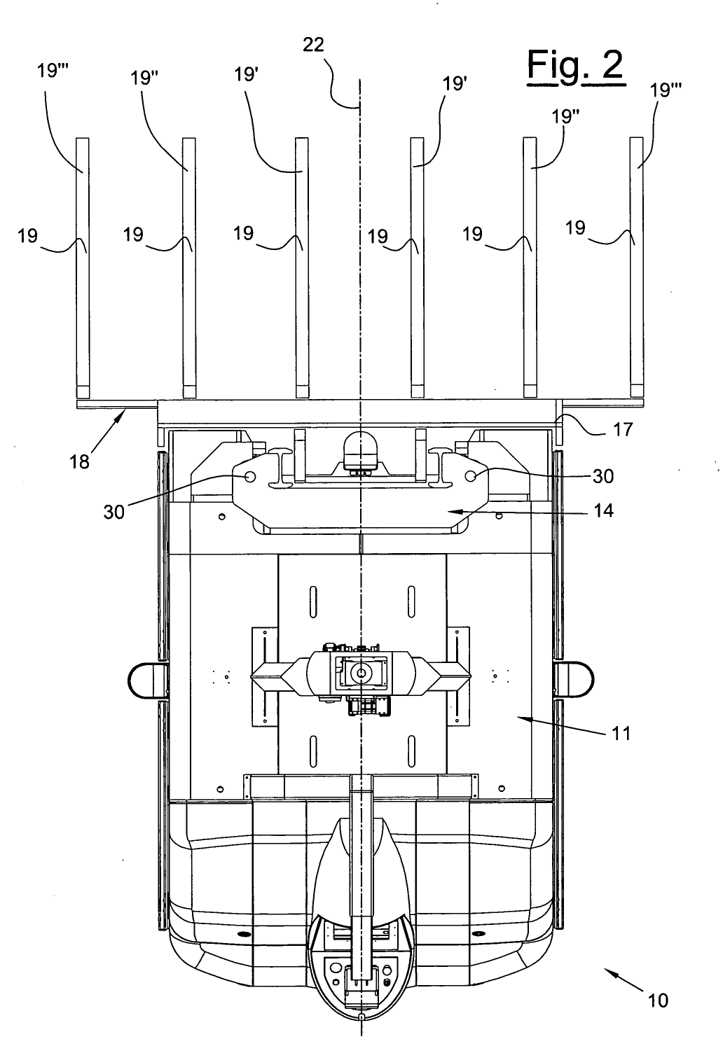

FIG. 2 is a schematic top-view of the vehicle of FIG. 1;

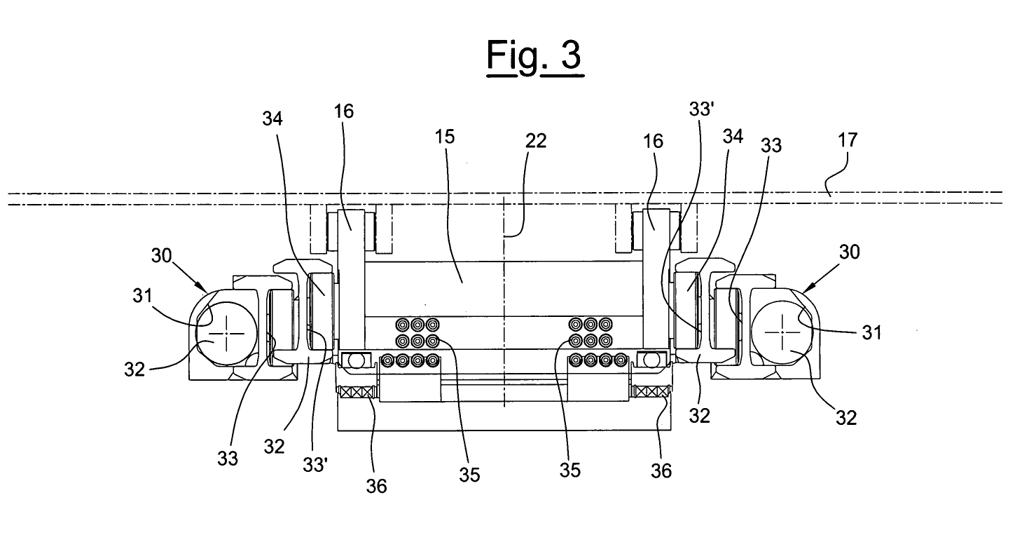

FIG. 3 is a schematic cross-section along lines III-III of FIG. 1 of a detail of the lifting group according to the invention;

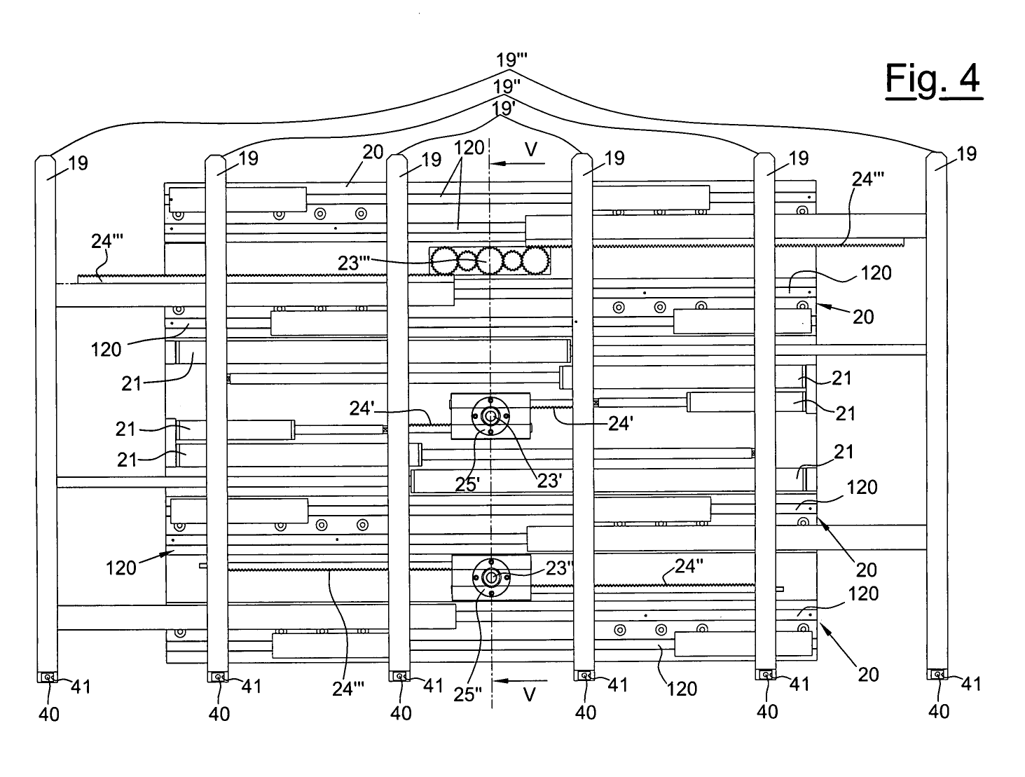

FIG. 4 is a schematic front view of the multi-pallet clamp group of the vehicle of FIG. 1;

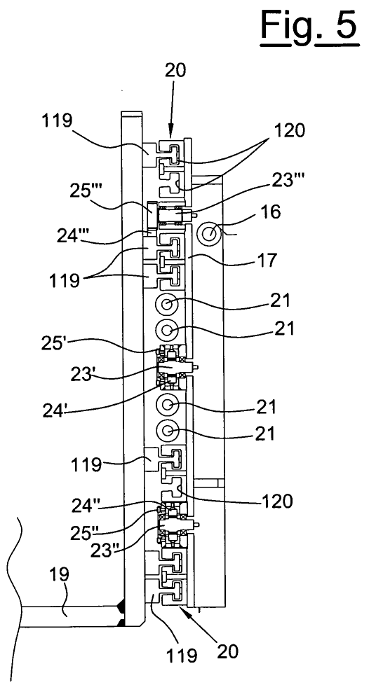

FIG. 5 is a cross-sectional view of the clamp group according to line V-V of FIG. 4;

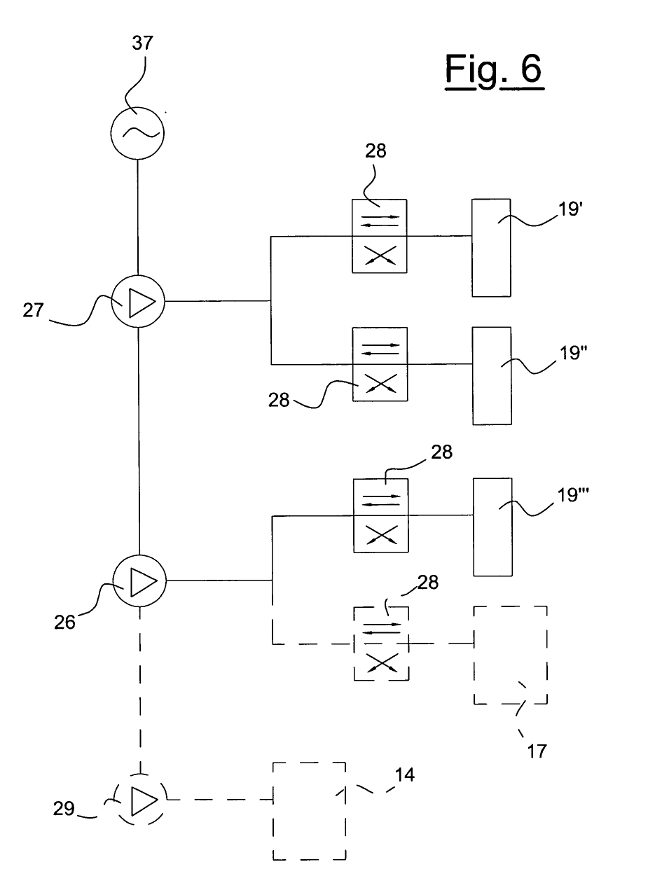

FIG. 6 shows a simplified hydraulic scheme of distribution of oil to the systems.

With reference to the figures, an automatic guided vehicle with an improved multiple-pallet lifting group is shown and indicated in its entirety by number 10.

A schematic example of such a vehicle 10, according to the present invention is represented, respectively with a side view and a top-view, in FIGS. 1 and 2.

Such a vehicle 10, similarly to the devices known and used today, comprises a machine body 11 provided with means, such as for example a drive wheel 12, for its movement.

This vehicle 10 moves horizontally on the plane on which it lies and it is capable of nearing the products intended to be transferred and subsequently reach the position at which the same are intended to be laid. Such movements can be controlled manually by an operator not on board with a “joystick type” control device, otherwise they can be preset and subsequently performed in an autonomous manner by the vehicle 10 through communication with a computer referred to as a supervisor.

Furthermore, vehicle 10, still similarly to the devices known today, comprises a lifting group 13 constrained, at the rear part, to the machine body 11.

This lifting group 13 comprises a vertical multi-level post structure 14, provided with a fixed part 31 directly constrained to the body of the machine 11 and with a moveable part. 32, to which a vertically sliding lift truck 15 is constrained through a system of pulleys and chains. In addition, the lifting group 13 comprises a tilting plate 17, hinged to the lift truck 15, which forms the framework of a clamp group 18, frontally constrained to it.

The clamp group of the vehicle 10 according to the invention is provided with three pairs of forks 19, an internal pair 19′, an intermediate pair 19″ and an external pair 19′″.

Each of these three pairs of forks 19 is arranged in a specular manner with respect to a longitudinal centreline plane 22 of the machine body 11. Each fork 19 is moveable horizontally with respect to the abovementioned plate 17, moving on horizontal guides 20 constrained to it. According to a preferred embodiment, provided for exemplification purposes, each fork 19 is provided with a slider 119 with a T-shaped profile for a sliding coupling within a complementary groove 120 of the horizontal guides 20.

According to the invention, as observable in FIGS. 4 and 5, the horizontal motion of each fork 19 is controlled by a relative actuator 21. Thus, six actuators 21 are used for six forks 19.

Additionally, according to the invention, each pair of forks 19′, 19″ and 19′″ comprises a pair of oppositely positioned racks 24′, 24″ e 24′″; each rack 24 is joined integrally to its respective fork 19.

At the centreline plane 22 the plate 17 is provided with at least one toothed wheel 23′, 23″ and 23′″ which meshes with the respective pairs of racks 24′, 24″ and 24′″, thus attaining the simultaneous movement of the forks 19 of each pair.

In FIG. 4, the pairs of racks joined integrally with the central 19′ and intermediate 19″ pairs of forks mesh with the respective pinion 23 and 23″ arranged at the centreline plane 22. The pair of racks 24′″ joined integrally with the external pair of forks 19′″ instead meshes with a gearing, comprising five toothed wheels, among which a central toothed wheel 23′″ at the centreline plane 22.

A sensor of the encoder type 25′, 25″, 25′″, is connected on the pin of each pinion 23′ and 23″ and of the central toothed wheel 23′″ of the gearing, as shown in FIG. 5, adapted to measure the movement of the forks 19 from the relative pair depending on the position of the pair of racks 24 connected to it. In FIG. 4, on the other hand, the gearing is shown partially broken away and thus the encoder 25′″ connected to the central toothed wheel 23′″ is not visible.

According to the example shown in FIG. 4 the actuators 21 are actuated hydraulically and it is provided that both the hydraulic actuators operating on a relative pair of forks 19 are controlled by a common pump exclusively dedicated to them.

According to the details schematically shown in figure 6, the system made up by the actuators 21 connected to the forks 19 belonging to the external pair 19′″, is supplied by a pump 26 exclusively dedicated to it.

The pair of internal 19′ and intermediate 19″ forks, that is the actuators 21 connected to the respective forks 19, are alternatively supplied by the same shared pump 27. The electronic control of the vehicle determines the use of the shared pump 27 by a system compared to another through electric valves 28 arranged on the circuit of each system. In this manner, when performing the position adjustment operations of the forks 19, at a first step the external 19′″ and intermediate 19″ pair of forks are thus positioned due to the simultaneous intervention of their respective pumps 26 and 27. At the end of the travel of the intermediate forks 19″, the shared pump 27 which controlled them can subsequently serve the pair of internal forks 19′, blocked up to that point, while the external forks 19′″, served by the special pump 26, continue their opening until the desired positioned has been attained.

According to a preferred embodiment, shown in the chart of FIG. 6, the special pump 26 which serves the pair of external forks 19′″can be shared with other systems, such as the tilting plate 17 hydraulic device, used when the horizontal position of the forks 19 has already been adjusted. In FIG. 6 this further system is indicated by a dashed line due to the fact that it is not controlled by the actuators 21 for the adjustment of the relative position between the forks.

Lastly, another pump 29, also indicated by a dashed line, is meant for vertical lifting of the post structure 14.

The hydraulic operation of the circuit shown schematically is of the known type and not described further in details. The pumps, of the gearing type, are mounted in series and run by a motor 37.

With reference to the details shown in FIG. 3, and in particular to the connections between the elements composing the lifting group 13, the lifting movement of the clamp group 18 is determined.

The support structure 14 shown is composed of two parallel vertical hydraulic actuators 30, in which a fixed part 31 has, on the side facing the symmetry plane 22, a “double T” shaped vertical guide 33 and a moveable part 32, vertically extendable beyond the relative fixed portion 31, is connected at an upper end to a “double T” shaped vertical guide 33′.

The lift truck 15, as observable in FIG. 3, has sliding coupling means 34, such as rotating bearings, arranged right inside the abovementioned vertical guides 33′.

Thus due to its rotating bearings, the lift truck 15 can move vertically with respect to the post structure 14 and such motion is transmitted, according to a preferred embodiment shown in FIG. 3, by pulleys 35 and chains 36 which are constrained at one end to the lift truck 15 and at the other end to the moveable portions 32 of the post structure 14.

Thus, lifting the moveable portions 32, they also draw the lift truck 15 vertically. Lastly, the rotating coupling means 16 of the tilting plate 17 with respect to the lift truck 15, as shown in FIG. 3, are two horizontal-axis hinges which connect, at the upper part, plate 17 to the lift truck 15.

In such manner, a tilting rotation of the plate 17 is allowed for enhanced stability of the pallets against the forks 19 when moving them. According to the invention, in order to enhance safety and accuracy when using the vehicle 10, the forks 19 comprise optical sensors 40, mounted at their ends in special seats 41, for optical scanning of the space in front of the forks 19 themselves.

For example, these optical sensors 40 can be optical sensors of the photocell type.

With the same objective, that is enhancing safety and accuracy of the automatic guided vehicle 10 during use, according to the invention other sensors, not shown, are also provided to signal the stop of the horizontal movement of the forks 19. For example these further sensors can be devices of the inductance or detector magnetic type.

The main aspect of the invention, as indicated beforehand, is the presence of a pair of racks 24′, 24″ and 24′″ coupled with each pair of forks 19′, 19″ and 19″.

Such coupling can be of various type and, as a matter of fact, as shown in FIG. 4, the racks 24 can be directly connected to the relative forks 19, otherwise they can be connected to an end of the actuator 21 at the point where it is connected to the relative fork 19.

The operation of the automatic guided vehicle with an improved multiple-pallet lifting group subject of the present invention is very easy to understand.

The automatic guided vehicle according to the present invention allows, similarly to the devices known today, to move products stacked in pallets from an initial position to another.

However in particular, the subject of the present invention has an improved multiple-pallet lifting group for automatic guided vehicles.

As a matter of fact, given that each fork is provided with its own special actuator, a more accurate movement of the two forks composing the same pair is obtained.

Additionally, such fact, that is the fact that each fork is connected to a special actuator, allows the vehicle to position all the pairs of forks according to a non-permanent and non-preset centre distance, but variable depending on the requirements.

For example, this allows to position the forks 19 for seizure of one, two or three pallets, respectively nearing all the pairs of forks, nearing the central and intermediate ones or else positioning them distant from each other as shown in FIG. 4.

The presence of racks connected to the forks provides an ideal synchronisation of the same. In addition, by converging the racks in a pinion provided with a sensor, it detects the horizontal position at any time.

The multiple-pallet clamp group 18, according to the invention, provides possibility to keep the pallets already held on the forks apart. As a matter of fact, in order to move two adjacent forks belonging to two separate pairs of forks with a simultaneous movement, that is at the same speed, the presence of pumps dedicated to each simultaneous movement and a further mechanical constraint of the racks is required.

Lastly, the automatic guide vehicle of the present invention has many safety devices in order to obtain proper positioning of the pallets during picking up and laying down operations.

Furthermore, due to the various optical and/or magnetic sensors provided for on the forks an ideal level of safety is obtained.

It has thus been observed that a vehicle with an improved multiple-pallet lifting group for automatic guided vehicles according to the present invention attains the objectives described beforehand.

The automatic guided vehicle with an improved multiple-pallet lifting group of the present invention thus conceived is susceptible to various modifications and variants, all of which fall within the same inventive concept; furthermore all details can be replaced by other technically equivalent elements. In practice, the material used, alongside their dimensions, may vary depending on the technical requirements.

1. Automatic guided vehicle (10) with an improved multiple-pallet lifting group comprising a machine body (11) provided with means for its movement (12) and a lifting group (13) constrained to said machine body (11), wherein said lifting group (13) comprises a multilevel post structure (14) provided with a fixed part (31) directly constrained to said machine body (11) and with a moveable part (32), a lift truck (15) constrained in a vertically sliding manner to said moveable part (32), a tilting plate (17), hinged to said lift truck (15), which constitutes the framework of the clamp group (18), frontally constrained to said plate (17), characterised in that said clamp group (18) comprises three pairs (19′, 19″, 19′″) of forks (19), each arranged in a specular manner with respect to a longitudinal centreline plane (22) of said machine body (11) and moveable along horizontal guides (20) constrained to said plate (17), and in that said clamp group (18) comprises per each pair (19′, 19″, 19′″) of forks (19) two actuators (21) for an independent control of each of said forks (19), a pair (24′, 24″, 24′″) of oppositely positioned racks (24) joined integrally to the respective forks (19) and at least one toothed wheel (23′, 23″, 23′″) which engages said corresponding pair of racks (24′, 24″, 24′″).

2. Vehicle according to claim 1, characterised in that it comprises a sensor (25′, 25″, 25′″) associated to said at least one toothed wheel (23′, 23″, 23′″) to detect the position of said pair (19′, 19″, 19′″) of forks (19).

3. Vehicle according to claim 1, characterised in that said actuators (21) are hydraulic actuators constrained at an end to said plate (17) and at an opposite end to said forks (19).

4. Vehicle according to claim 3, characterised in that both the hydraulic actuators (21) operating on a pair of said forks (19) are controlled by a common pump (26, 27).

5. Vehicle according to claim 4, characterised in that a dedicated pump (26) supplies the actuators (21) of said external pair (19′″) of forks (19) and a shared pump (27) alternatively supplies the actuators of said pair of internal (19′) and intermediate (19″) forks wherein electric valves (28) positioned on the circuit of each system control the supply to said systems.

6. Vehicle according to claim 1, characterised in that said forks (19) comprise seats (41) at their ends for optical sensors (40) for optical scanning of the space in front of said forks (19).

7. Vehicle according to claim 6, characterised in that said optical sensors (40) are optical sensors of the photocell type.

8. Vehicle according to claim 1, characterised in that said racks (24) are directly connected to said forks (19).

9. Vehicle according to claim 3, characterised in that said racks (24) are connected to said ends of said hydraulic actuators (21) connected to said forks (19).

10. Vehicle according to claim 2, characterised in that said sensors (25′, 25″, 25′″) are encoders for measuring the movement of said forks (19).

11. Vehicle according to claim 1, characterised in that said post structure (14) comprises two parallel vertical hydraulic actuators (30), in which said fixed part (31) comprises a hydraulic cylinder associated to a “double T” shaped vertical guide (33) and said moveable part (32), which is vertically extendable beyond said fixed part (31), is connected at the upper end to a “double T” shaped vertical guide (33′).

12. Vehicle according to claim 11, characterised in that said lift truck (15) comprises sliding coupling means (34) with respect to said post structure (14) composed of rotating bearings inside said vertical guides (33′) associated to said moveable part (32).

13. Vehicle according to claim 1, characterised in that said post structure (14) comprises pulleys (35) and chains (36) constrained at an end to said lift truck (15) and at the other end to said moveable portions (32) for transmitting vertical motion of said lift truck (15) with respect to said post structure (14).

14. Vehicle according to claim 1, characterised in that said post structure (14) comprises two horizontal-axis hinges (16) which join, at the upper part, said plate (17) and said lift truck (15) to allow the a tilting rotation of said plate (17).
